(19) United States
(12) Patent Application Publication
(10) Pub. No.: US 2026/0229811 A1
(43) Pub. Date: Aug. 6, 2026

(54) CONNECTOR AND ELECTRONIC DEVICE INCLUDING SAME

(71) Applicant: Samsung Electronics Co., Ltd., Suwon-si (KR)

(72) Inventors: Waneui JUNG, Suwon-si (KR); Hanseok MUN, Suwon-si (KR); Jaeryong HAN, Suwon-si (KR)

(21) Appl. No.: 19/636,367

(22) Filed: Apr. 1, 2026

Related U.S. Application Data
(63) Continuation of application No. PCT/KR2024/016668, filed on Oct. 29, 2024.

(30) Foreign Application Priority Data
Nov. 1, 2023 (KR) 10-2023-0148942
Dec. 6, 2023 (KR) 10-2023-0175616

(51) Int. Cl. H01R 13/52; H01R 12/72; H04M 1/02

(52) U.S. Cl. CPC H01R 13/5202; H01R 12/722; H04M 1/0277

(57) ABSTRACT

A connector is provided. The connector includes a fixing portion, a connection portion extending in a first direction from the fixing portion, a first cover member disposed to surround at least a portion of the fixing portion, a second cover member disposed adjacent to the fixing portion or the first cover member, the second cover member surrounding at least a portion of the connection portion, and a plurality of contact terminals extending from the fixing portion, the plurality of contact terminals being partially exposed to an outside of the second cover member on one surface of the connection portion, the plurality of contact terminals being are arranged along a second direction intersecting the first direction.

### CROSS-REFERENCE TO RELATED APPLICATION(S

This application is a continuation application, claiming priority under 35 U.S.C. § 365(c), of an International application No. PCT/KR2024/016668, filed on October 29, 2024, which is based on and claims the benefit of a Korean patent application number 10-2023-0148942, filed on November 1, 2023, in the Ministry of Intellectual Property (MOIP), and of a Korean patent application number 10-2023-0175616, filed on December 6, 2023, in the Ministry of Intellectual Property (MOIP), the disclosure of each of which is incorporated by reference herein in its entirety.

### BACKGROUND

### 1. Field

The disclosure relates to an electronic device. More particularly, the disclosure relates to a connector and/or an electronic device including the same.

### 2. Description of Related Art

As electronic, information and communication technologies have developed, various functions have come to be included into a single electronic device. For example, a smartphone may include functions of a sound playback device, an imaging device, or a digital diary, in addition to a communication function, and more diverse functions may be implemented in a smartphone through installation of additional applications. An electronic device may be provided with various pieces of information in real time by accessing a server or another electronic device in a wired or wireless manner as well as by executing an installed application or a stored file.

As electronic devices have advanced in performance and become smaller in size, carrying and using electronic devices have become commonplace, and portable electronic devices are being provided in various forms. For example, an individual user may carry and use a plurality of portable electronic devices such as a smartphone, a tablet personal computer (PC), a smartwatch, wireless earphones, and/or smart glasses. As the use of such portable electronic devices becomes more prevalent and the time of use in outdoor environments increases, users’ demand for portability of electronic devices may increase. For example, users may prefer lighter and more compact electronic devices while also requiring further enhancement of performance such as image quality or sound quality.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a connector and/or an electronic device including the same.

Additional aspects will be set forth in part in the description which follows and, in part, will be apparent from the description, or may be learned by practice of the presented embodiments.

In accordance with an aspect of the disclosure, a connector is provided. The connector includes a fixing portion, a connection portion extending in a first direction from the fixing portion, a first cover member disposed to surround at least a portion of the fixing portion, a second cover member disposed adjacent to the fixing portion or the first cover member, the second cover member surrounding at least a portion of the connection portion, and a plurality of contact terminals extending from the fixing portion, the plurality of contact terminals being partially exposed to an outside of the second cover member on one surface of the connection portion, the plurality of contact terminals being arranged along a second direction intersecting the first direction.

In accordance with another aspect of the disclosure, a connector is provided. The connector includes a fixing portion, a connection portion extending in a first direction from the fixing portion, a first cover member disposed to surround at least a portion of the fixing portion, a second cover member disposed adjacent to the fixing portion or the first cover member, the second cover member surrounding at least a portion of the connection portion, a plurality of contact terminals extending from the fixing portion, the plurality of contact members being partially exposed to an outside of the second cover member on one surface of the connection portion, the plurality of contact terminals being arranged along a second direction intersecting the first direction, a first sealing member disposed between the connection portion and an inner circumferential surface of the second cover member, and a second sealing member disposed to surround at least a portion of an outer circumferential surface of the second cover member, wherein the second cover member includes a base portion disposed to either face the fixing portion or be integrally formed with the first cover member and contact the second sealing member on an outer surface of the base portion, and a support portion protruding from the base portion in the first direction, the support portion being disposed to surround the connection portion, wherein the second sealing member contacts an outer surface of the support portion, and wherein the first sealing member contacts an inner surface of the support portion.

In accordance with another aspect of the disclosure, an electronic device is provided. The electronic device includes a housing including a front surface, a rear surface facing in a direction opposite to the front surface, and a side wall disposed to surround at least a portion of a space between the front surface and the rear surface, a connector hole formed through the side wall, a partition disposed inside the housing at a predetermined distance from the side wall, the partition facing the connector hole, and a connector disposed inside the housing, wherein the connector includes a fixing portion disposed on one side of the partition, a connection portion extending in a first direction from the fixing portion, the connection portion being disposed to pass through the partition such that the connection portion directly faces the connector hole, a first cover member disposed to surround at least a portion of the fixing portion, a second cover member disposed adjacent to the fixing portion or the first cover member, the second cover member surrounding at least a portion of the connection portion, a first sealing member disposed between the connection portion and an inner circumferential surface of the second cover member, and a second sealing member disposed to surround at least a portion of an outer circumferential surface of the second cover member and directly contact the partition.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device within a network environment according to an embodiment of the disclosure;

FIG. 2 is a front perspective view of an electronic device according to an embodiment of the disclosure;

FIG. 3 is a rear perspective view of the electronic device illustrated in FIG. 2 according to an embodiment of the disclosure;

FIG. 4 is an exploded perspective view illustrating the front side of an electronic device according to an embodiment of the disclosure;

FIG. 5 is an exploded perspective view illustrating the rear side of an electronic device according to an embodiment of the disclosure;

FIG. 6 is a perspective view illustrating a molded body of a connector according to an embodiment of the disclosure;

FIG. 7 is a perspective view illustrating a state in which a second cover member is coupled to a molded body of the connector according to an embodiment of the disclosure;

FIG. 8 is a perspective view illustrating a state in which a first cover member is coupled to a molded body of the connector according to an embodiment of the disclosure;

FIG. 9 is a perspective view illustrating a connector in a state in which a second sealing member is disposed on a second cover member according to an embodiment of the disclosure;

FIG. 10 is a plan view illustrating a connector according to an embodiment of the disclosure;

FIG. 11 is a bottom view illustrating a connector according to an embodiment of the disclosure;

FIG. 12 is a cross-sectional view illustrating a connector taken along line A-A′ of FIG. 10 according to an embodiment of the disclosure;

FIG. 13 is a view illustrating a state in which a connector is disposed in a housing of an electronic device according to an embodiment of the disclosure;

FIG. 14 is a perspective view illustrating a connector according to an embodiment of the disclosure;

FIG. 15 is a cross-sectional view illustrating the connector taken along line B-B′ of FIG. 14 according to an embodiment of the disclosure;

FIG. 16 is an exploded perspective view illustrating a connector according to an embodiment of the disclosure;

FIG. 17 is a perspective view illustrating the connector, in which a portion of the connector is cut away according to an embodiment of the disclosure;

FIG. 18 is a view illustrating a circuit board to which a connector is coupled according to an embodiment of the disclosure;

FIG. 19 is a cross-sectional view illustrating a connector, in which a portion of the connector is cut away according to an embodiment of the disclosure; and

FIG. 20 is a perspective view illustrating the connector, in which a portion of the connector is cut away according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Generally, an electronic device such as a smartphone may include a connector compliant with a protocol such as a universal serial bus (USB), thereby being connected to another electronic device in a wired manner or receiving power for operation or charging. Although efforts have been made to eliminate connectors that implement mechanical connections as connection to another electronic device or power supply becomes possible through wireless methods, such as near-field wireless communication or wireless power transmission and reception, a wired method may still provide higher speed and efficiency than a wireless method. However, such connectors may hinder miniaturization or weight reduction of the electronic devices. For example, an electronic device from which a connector is omitted may be more easily miniaturized and lightened than an electronic device including a connector. When a connector for connection with the outside is disposed in an electronic device capable of daily-life waterproofing, additional space may be required to implement a waterproofing structure, and thus miniaturization of an electronic device including the connector may be more difficult.

An embodiment of the disclosure is intended to at least address the above-described issues and/or disadvantages and to at least provide advantages described below, and may provide a miniaturized connector and/or an electronic device including the same, which facilitates miniaturization and/or enables daily-life waterproofing.

The technical issues to be addressed by the disclosure are not limited to those described above, and other technical issues may be clearly understood by a person ordinarily skilled in the art to which the disclosure pertains.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

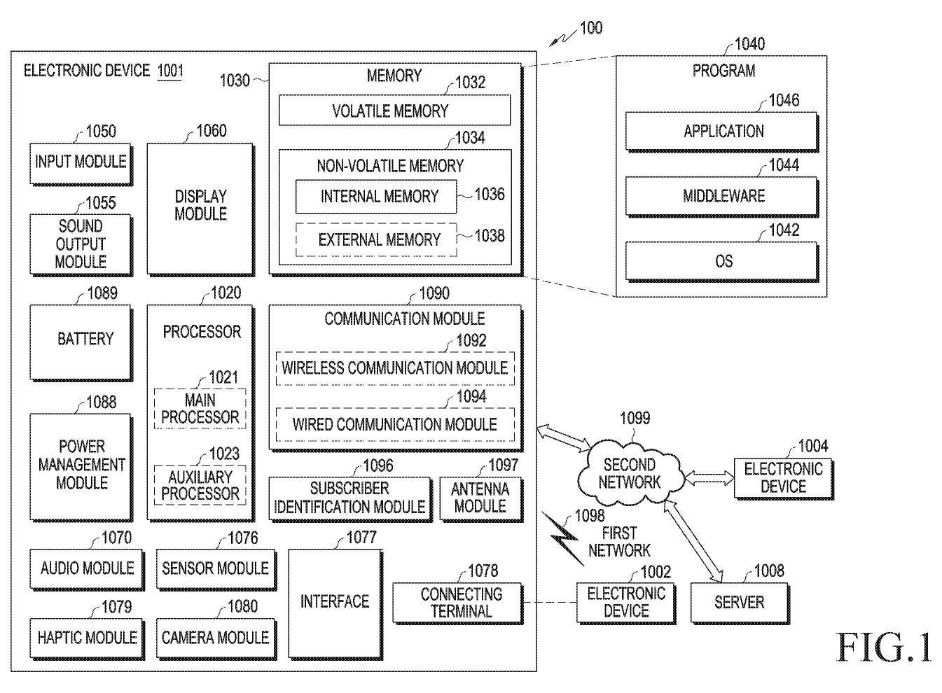

FIG. 1 is a block diagram illustrating an electronic device 1001 in a network environment 1000 according to an embodiment of the disclosure.

Referring to FIG. 1, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to one embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to one embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth^{TM}, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the millimeter wave (mmWave) band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on fifth generation (5G) communication technology or IoT-related technology.

The electronic device according to embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

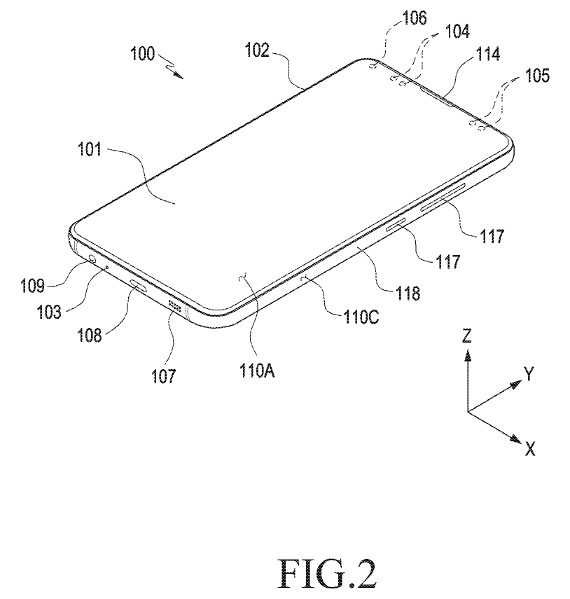

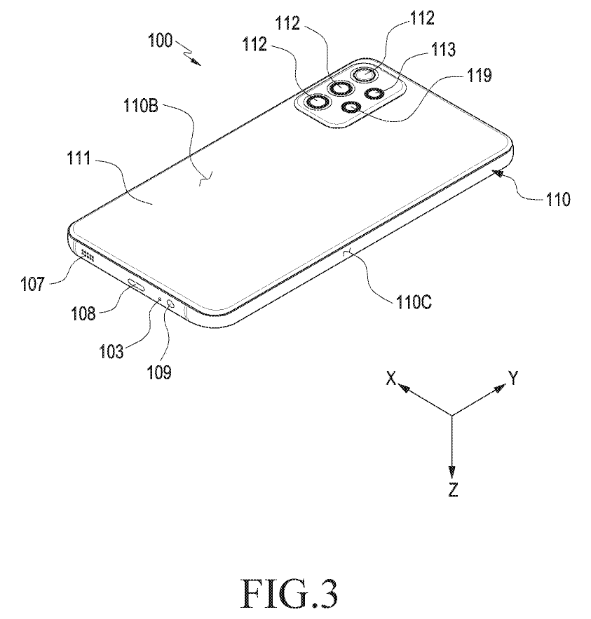

FIG. 2 is a front perspective view of an electronic device 100 according to an embodiment of the disclosure. FIG. 3 is a rear perspective view of the electronic device 100 of FIG. 2 according to an embodiment of the disclosure.

Referring to FIGS. 2 and 3, the electronic device 100 (e.g., the electronic device 1001 in FIG. 1) according to an embodiment may include a housing 110 including a first surface (or the front surface) 110A, a second surface (or the rear surface) 110B, and a side surface 110C surrounding the space between the first surface 110A and the second surface 110B. In an embodiment (not illustrated), the housing 110 may refer to a structure that forms a portion of the first surface 110A of FIG. 2, and the second surface 110B and the side surface 110C of FIG. 3. According to an embodiment, at least a portion of the first surface 110A may be defined by a substantially transparent front surface plate 102 (e.g., a glass plate or a polymer plate including various coating layers). The second surface 110B may be defined by a substantially opaque rear surface plate 111. The rear surface plate 111 may be made of, for example, coated or colored glass, ceramic, polymer, metal (e.g., aluminum, stainless steel (STS), or magnesium), or a combination of two or more of these materials. The side surface 110C may be defined by the side structure (or a “side bezel structure”) 118 coupled to the front surface plate 102 and the rear surface plate 111 and including metal and/or polymer. In an embodiment, the rear surface plate 111 and the side structure 118 may be integrated with each other and may include the same material (e.g., a metal material such as aluminum).

Although not illustrated, the front surface plate 102 may include one or more regions that are curved and extend seamlessly from at least a portion of an edge toward the rear surface plate 111. In an embodiment, the front surface plate 102 (or the rear surface plate 111) may include only one of the regions curved and extended toward the rear surface plate 111 (or the front surface plate 102), at one side edge of the first surface 110A. According to an embodiment, the front surface plate 102 or the rear surface plate 111 may be substantially flat in shape. For example, the front or rear surface plate may not include an area that is curved and extended. When the curved and extended region is included, the thickness of the electronic device 100 in the portion including the curved and extended region may be smaller than the thicknesses of other portions.

According to an embodiment, the electronic device 100 may include at least one of a display 101, an audio module (e.g., a microphone hole 103, an external speaker hole 107, and a receiver hole 114 for a call), a sensor module (e.g., a first sensor module 104, a second sensor module (not illustrated), and a third sensor module 119), a camera module (e.g., a first camera device 105, a second camera device 112, and a flash 113), key input devices 117, a light-emitting element 106, and connector holes (e.g., a first connector hole 108 and a second connector hole 109). In an embodiment, at least one of the components (e.g., the key input devices 117 or the light-emitting element 106) may be omitted from the electronic device 100 or other components may be additionally included.

The display 101 may output a screen or may be visually exposed through, for example, a significant portion of the first surface 110A (e.g., the front surface plate 102). In an embodiment, at least a portion of the display 101 may be visually exposed through the front surface plate 102 forming the first surface 110A or through a portion of the side surface 110C. In an embodiment, a corner of the display 101 may be formed to be substantially the same as the outer shape of the front surface plate 102 adjacent thereto. In an embodiment (not illustrated), the distance between the periphery of the display 101 and the periphery of the front surface plate 102 may be substantially constant in order to increase the visually exposed area of the display 101.

In an embodiment (not illustrated), recesses or openings may be provided in some portions of the screen display region of the display 101, and one or more of an audio module (e.g., the receiver hole 114 for a call), a sensor module (e.g., the first sensor module 104), a camera module (e.g., the first camera module 105), and a light-emitting element 106 may be aligned with the recesses or the openings. In an embodiment (not illustrated), the rear surface of the screen display region of the display 101 may include at least one of an audio module (e.g., the receiver hole 114 for a call), a sensor module (e.g., the first sensor module 104), a camera module (e.g., the first camera device 105), a fingerprint sensor (not illustrated), and a light-emitting element 106. In an embodiment (not illustrated), the display 101 may be coupled to or disposed adjacent to a touch-sensitive circuit, a pressure sensor capable of measuring a touch intensity (pressure), and/or a digitizer configured to detect an electromagnetic field-type stylus pen. In an embodiment, when the front surface plate 102 or the rear surface plate 111 includes one or more curved and extended regions, at least a portion of the sensor modules (e.g., the first sensor module 104 and the third sensor module 119), and/or at least a portion of the key input devices 117 may be arranged in the one or more curved and extended regions.

The audio module 103, 107, and 114 may include a microphone hole 103 and speaker holes (e.g., the external speaker hole 107 and the receiver hole 114 for a call). A microphone configured to acquire external sound may be disposed inside the microphone hole 103, and in an embodiment, multiple microphones may be disposed to detect the direction of sound. The speaker holes may include the external speaker hole 107 and the receiver hole 114 for a call. In an embodiment, the speaker holes (e.g., the external speaker hole 107 and the receiver hole 114 for a call) and the microphone hole 103 may be implemented as a single hole, or a speaker (e.g., a piezo speaker) may be included without the speaker holes (e.g., the external speaker hole 107 and the receiver hole 114 for a call).

The sensor modules may generate electrical signals or data values corresponding to the internal operating states or the external environmental states of the electronic device 100. The sensor modules may include, for example, a first sensor module 104 (e.g., a proximity sensor) and/or a second sensor module (not illustrated) (e.g., a fingerprint sensor) disposed on the first surface 110A of the housing 110, and/or a third sensor module 119 disposed on the second surface 110B of the housing 110. The second sensor module (not illustrated) (e.g., a fingerprint sensor) may be disposed not only on the first surface 110A (e.g., the display 101) of the housing 110, but also on the second surface 110B or the side surface 110C of the housing 110. The electronic device 100 may further include at least one of, for example, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

The camera modules may include a first camera device 105 disposed on the first surface 110A of the electronic device 100, and a second camera device 112 and/or a flash 113 disposed on the second surface 110B of the electronic device 100. The camera devices (e.g., the first camera device 105 and the second camera device 112) may include one or more lenses, an image sensor, and/or an image signal processor. The flash 113 may include, for example, a light-emitting diode or a xenon lamp. In an embodiment, one or more lenses (e.g., an infrared camera lens, a wide-angle lens, and a telephoto lens) and image sensors may be disposed on one surface of the electronic device 100. In an embodiment, the flash 113 may emit infrared light, and the infrared light emitted by the flash 113 and reflected by a subject may be received through the third sensor module 119. The electronic device 100 or a processor (e.g., the processor 1020 in FIG. 1) of the electronic device 100 may detect depth information of a subject based on a time point when the infrared light is received by the third sensor module 119.

The key input devices 117 may be disposed on the side surface 110C of the housing 110. In an embodiment, the electronic device 100 may not include some or all of the above-described key input devices 117, and a key input device 117 not included may be implemented in another form, such as a soft key, on the display 101. In an embodiment, the key input devices may include a sensor module disposed on the second surface 110B of the housing 110.

The light-emitting element 106 may be disposed on, for example, the first surface 110A of the housing 110. The light-emitting elements 106 may provide, for example, the state information of the electronic device 100 in the form of light. In an embodiment, the light-emitting element 106 may provide a light source that operates in conjunction with, for example, the operation of the camera module (e.g., the first camera device 105). The light-emitting element 106 may include, for example, a light-emitting diode (LED), an infrared LED, and a xenon lamp.

The connector holes (e.g., a first connector hole 108 and a second connector hole 109) may include a first connector hole 108, which is capable of accommodating a connector (e.g., a USB connector) configured to transmit/receive power and/or data to/from an external electronic device (e.g., the electronic device 1002 in FIG. 1), and/or a second connector hole (e.g., an earphone jack) 109, which is capable of accommodating a connector for transmitting/receiving an audio signal to/from an external electronic device.

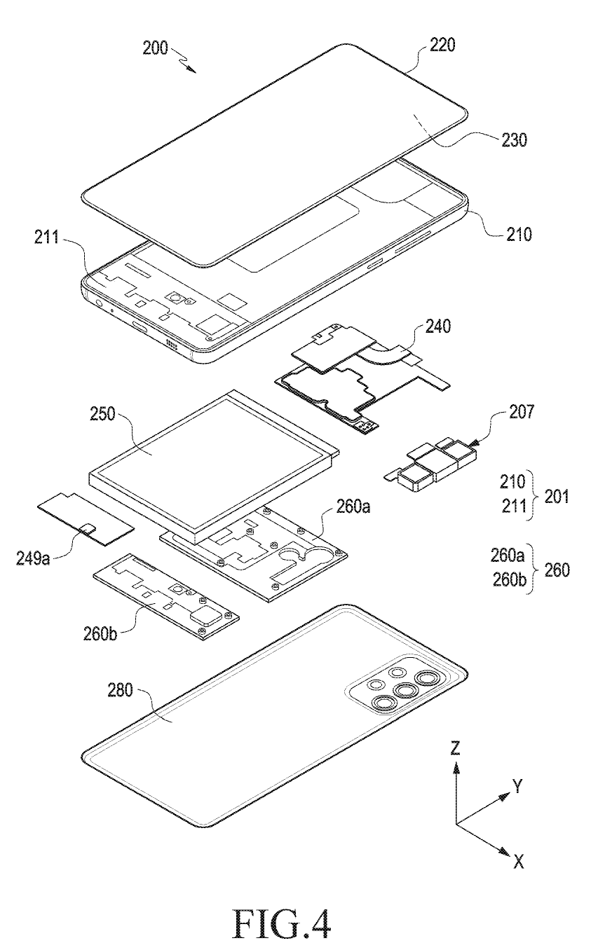

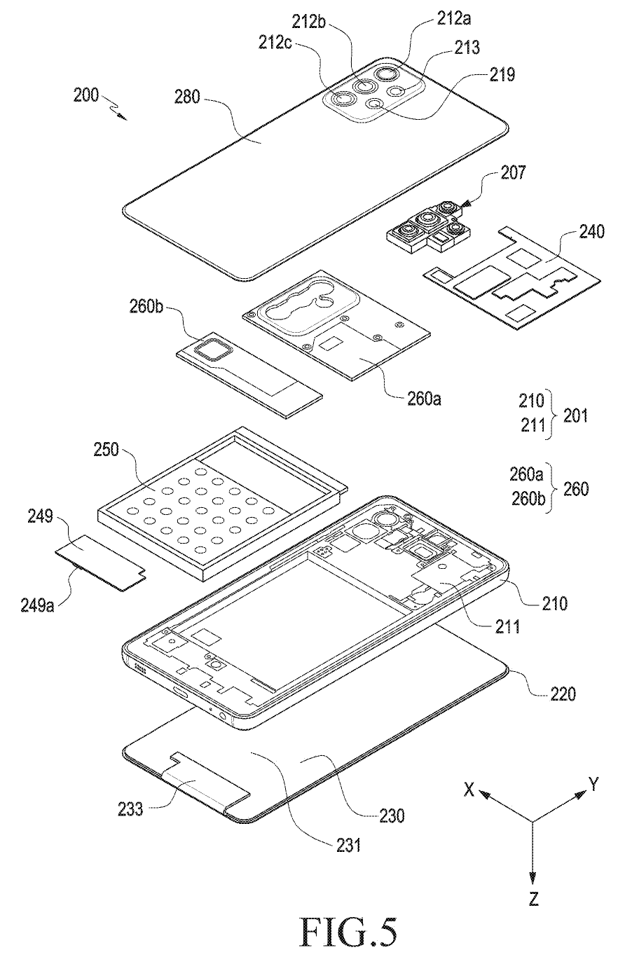

FIG. 4 is an exploded perspective view illustrating the front side of an electronic device 200 (e.g., the electronic device 100 illustrated in FIG. 2) according to an embodiment of the disclosure. FIG. 5 is an exploded perspective view illustrating the rear side of the electronic device 200 (e.g., the electronic device 100 illustrated in FIG. 2) according to an embodiment of the disclosure.

Referring to FIGS. 4 and 5, the electronic device 200 (e.g., the electronic device 1001, 1002, 1004, or 100 in FIGS. 1, 2, or 3) may include a side structure 210, a first support member 211 (e.g., a bracket), a front surface plate 220 (e.g., the front surface plate 102 in FIG. 2), a display 230 (e.g., the display 101 in FIG. 2), a printed circuit board (or a substrate assembly) 240, a battery 250, a second support member 260 (e.g., a rear case), an antenna (not illustrated) (e.g., the antenna module 1097 in FIG. 1), a camera assembly 207, and a rear surface plate 280 (e.g., the rear surface plate 111 in FIG. 3). In an embodiment, at least one of the components (e.g., the first support member 211 or the second support member 260) may be omitted from the electronic device 200, or may additionally include other components. At least one of the components of the electronic device 200 may be the same as or similar to at least one of the components of the electronic device 100 illustrated in FIGS. 2 or 3, and redundant descriptions are omitted below.

According to an embodiment, the first support member 211 may be disposed inside the electronic device 200 to be connected to the side structure 210, or may be integrated with the side structure 210. The first support member 211 may be made of, for example, a metal material and/or a non-metal (e.g., polymer) material. When at least partially made of a metal material, a portion of the side structure 210 or the first support member 211 may serve as an antenna. The first support member 211 may include one surface to which the display 230 is coupled and the other surface to which the printed circuit board 240 is coupled. A processor (e.g., the processor 1020 in FIG. 1), memory (e.g., the memory 1030 in FIG. 1), and/or an interface (e.g., the interface 1077 in FIG. 1) may be mounted on the printed circuit board 240. The processor may include one or more of, for example, a central processing unit, an application processor, a graphics processing unit, an image signal processor, a sensor hub processor, or a communication processor. In an embodiment, the processor and/or the memory may refer to one of the circuit devices mounted on an integrated circuit chip.

According to an embodiment, the electronic device 200 may further include at least one auxiliary circuit board 249 separate from the printed circuit board 240. The auxiliary circuit board 249 may include, for example, a connector 249a (e.g., the connection terminal 1078 of FIG. 1) for connection with an external electronic device or for power supply. In an embodiment, the connector 249a may be disposed inside the housing 201 and disposed to correspond to the first connector hole 108 of FIG. 2. In an embodiment, an input module 1050 (e.g., a microphone), an audio output module 1055 (e.g., a speaker) of FIG. 1, and an antenna (not illustrated) may be disposed around the auxiliary circuit board 249, and such electrical/electronic components may be electrically connected to the printed circuit board 240 via the auxiliary circuit board 249.

According to an embodiment, the first support member 211 and the side structure 210 may be combined and referred to as a front case or a housing 201. According to an embodiment, the housing 201 may be generally understood as a structure for accommodating, protecting, or disposing the printed circuit board 240 or the battery 250. In an embodiment, the housing 201 may be understood as including structures capable of being visually or tactually recognized by a user in the exterior of the electronic device 200, such as the side structure 210, the front surface plate 220, and/or the rear surface plate 280. In an embodiment, the “front surface or rear surface of the housing 201” may refer to the first surface 110A in FIG. 2 or the second surface 110B in FIG. 3. In an embodiment, the first support member 211 may be disposed between the front surface plate 220 (e.g., the first surface 110A in FIG. 2) and the rear surface plate 280 (e.g., the second surface 110B in FIG. 3) and may serve as a structure on which electrical/electronic components, such as a printed circuit board 240 or a camera assembly 207, are disposed.

The display 230 may include a display panel 231 and a flexible printed circuit board 233 extending from the display panel 231. The flexible printed circuit board 233 may be understood, for example, to be electrically connected to the display panel 231 while being disposed at least partially on the rear surface of the display panel 231. In an embodiment, reference numeral “231” may be understood as denoting a protective sheet disposed on the rear surface of the display panel. For example, unless otherwise classified in the following detailed description, the protective sheet may be understood as a portion of the display panel 231. In an embodiment, the protective sheet may function as a buffer structure (e.g., a low-density elastic material such as a sponge) absorbing an external force or an electromagnetic shield structure (e.g., a copper sheet (CU sheet)). According to an embodiment, the display 230 may be disposed on the inner surface of the front surface plate 220 and may include a light-emitting layer to output a screen through at least a portion of the first surface 110A of FIG. 2 or the front surface plate 220. As mentioned above, the display 230 may output a screen through substantially the entire area of the first surface 110A of FIG. 2 or the front surface plate 220.

The memory may include, for example, volatile memory or non-volatile memory.

The interface may include, for example, a high-definition multimedia interface (HDMI), a universal serial bus (USB) interface, an SD card interface, and/or an audio interface. For example, the interface may electrically or physically connect the electronic device 200 to an external electronic device, and include a USB connector, an SD card/MMC connector, or an audio connector.

The second support member 260 may include, for example, an upper support member 260a and a lower support member 260b. In an embodiment, the upper support member 260a may be disposed to surround the printed circuit board 240 together with a portion of the first support member 211. For example, the printed circuit board 240 may be substantially disposed between the first support member 211 and the second support member 260 (e.g., the upper support member 260a). A circuit device implemented in the form of an integrated circuit chip (e.g., a processor, a communication module, or memory) or various electrical/electronic components may be disposed on the printed circuit board 240, and in some embodiments, the printed circuit board 240 may be provided with an electromagnetic shielding environment from the upper support member 260a. In an embodiment, at least one shield may be disposed on the printed circuit board 240. For example, the shield may provide an electromagnetic shielding environment to a portion or space on the printed circuit board 240. In an embodiment, the shield may be disposed to surround at least a portion of an integrated circuit chip on which a processor, memory, and/or a communication module is mounted.

According to an embodiment, the lower support member 260b may be used as a structure for disposing electrical/electronic components such as the auxiliary circuit board 249, a speaker module, and an interface (e.g., a USB connector, an SD card/MMC connector, or an audio connector). In an embodiment, electrical/electronic components such as a speaker module and an interface (e.g., a USB connector, an SD card/MMC connector, or an audio connector) may be disposed on an additional printed circuit board (e.g., the auxiliary circuit board 249). For example, the lower support member 260b may be disposed to surround the additional printed circuit board together with another portion of the first support member 211. The speaker module or interface disposed on the auxiliary circuit board 249 or the lower support member 260b may be arranged to correspond to the audio module of FIG. 2 (e.g., the microphone hole 103 or the speaker holes (e.g., the external speaker hole 107 and the receiver hole 114 for a call)) or the connector holes (e.g., the first connector hole 108 and the second connector hole 109).

The battery 250 may serve as a device that supplies power to at least one component of the electronic device 200, and may include, for example, a non-rechargeable primary cell, a rechargeable secondary cell, or a fuel cell. At least a portion of the battery 250 may be, for example, disposed on substantially the same plane as the printed circuit board 240. The battery 250 may be integrally disposed inside the electronic device 200, or may be disposed to be detachable from the electronic device 200.

Although not illustrated, the antenna may include a conductive pattern implemented on the surface of the first support member 211 and/or the surface of the second support member 260, for example, through laser direct structuring (LDS) techniques. In an embodiment, the antenna may include a printed circuit pattern provided on the surface of a thin film, and the thin film-type antenna may be disposed between the rear surface plate 280 and the battery 250. The antenna may include, for example, a near-field communication (NFC) antenna, a wireless charging antenna, and/or a magnetic secure transmission (MST) antenna. The antenna may, for example, perform near-field communication with an external device, or wirelessly transmit and receive power required for charging. In an embodiment, another antenna structure may be configured with a portion or a combination of the side structure 210 and/or the first support member 211.

The camera assembly 207 may include at least one camera module. Inside the electronic device 200, the camera assembly 207 may detect at least some of light incident through optical holes or camera windows 212a, 212b, 212c, 213, and 219. In an embodiment, the camera assembly 207 may be disposed on the first support member 211 at a position adjacent to the printed circuit board 240. In an embodiment, the camera modules of the camera assembly 207 may be generally aligned with one of the camera windows 212a, 212b, 212c, 213, and 219, and may be at least partially surrounded by the second support member 260 (e.g., the upper support member 260a).

In discussing the embodiments described below, the above-described configurations of the electronic devices 1001, 1002, 1004, 100, and 200 may be referred to. Even if not directly mentioned, the configurations of the embodiments described above may be similarly applied to the embodiments described below. It should be noted that the orthogonal coordinate system referred to in an embodiment described above and/or described below is exemplified for the sake of brevity of explanation, and an embodiment(s) of the disclosure is(are) not limited thereto. For example, the orthogonal coordinate system mentioned in the disclosure may be defined differently depending on the shape of an electronic device to be actually manufactured (e.g., bar type, foldable type, rollable type, and/or slide type), a user’s usage habits, and/or the orientation direction of the electronic device.

In the following detailed description, the length direction, the width direction, and/or the thickness direction of an electronic device may be referred to, wherein the length direction may be defined as the “Y-axis direction,” the width direction may be defined as the “X-axis direction,” and/or the thickness direction may be defined as the “Z-axis direction.” In an embodiment, the direction in which a component is oriented may be mentioned along with the orthogonal coordinate system illustrated in the drawings, as well as the “negative/positive symbol (-/+).” For example, the front surface of an electronic device and/or a housing may be defined as a “surface oriented in the +Z direction,” and the rear surface may be defined as a “surface oriented in the -Z direction.” In an embodiment, a side surface of an electronic device and/or a housing may include an area oriented in the +X direction, an area oriented in the +Y direction, an area oriented in the -X direction, and/or an area oriented in the -Y direction. In an embodiment, the “X-axis direction” may include both the “-X direction” and the “+X direction.” It is noted that these are based on the orthogonal coordinate system illustrated in the drawings for the sake of brevity of description, and the descriptions of these directions or components do not limit one or more embodiments of the disclosure. For example, depending on the design specifications of an electronic device or a user’s usage habits, the orthogonal coordinate system may be defined differently from that disclosed therein.

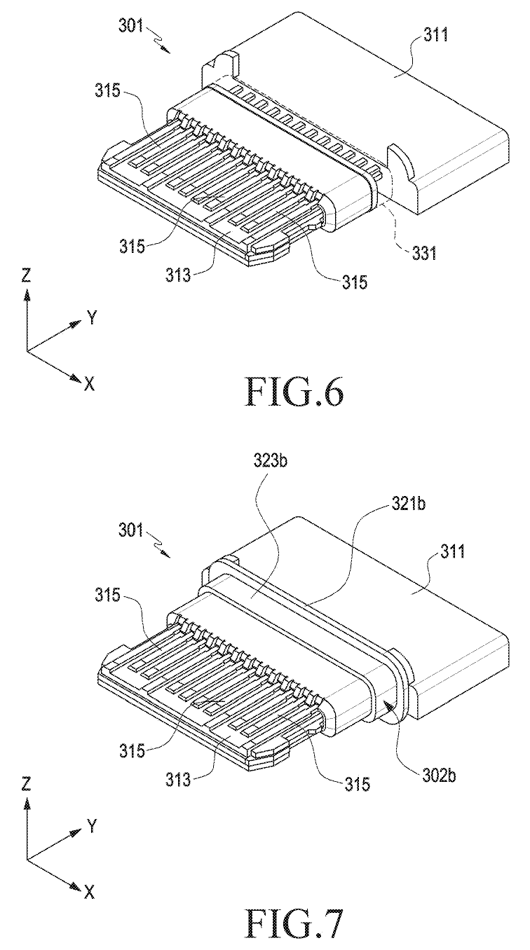

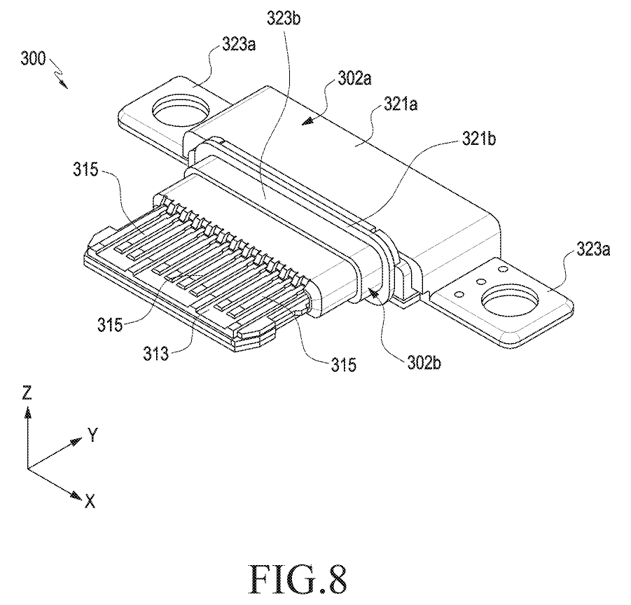

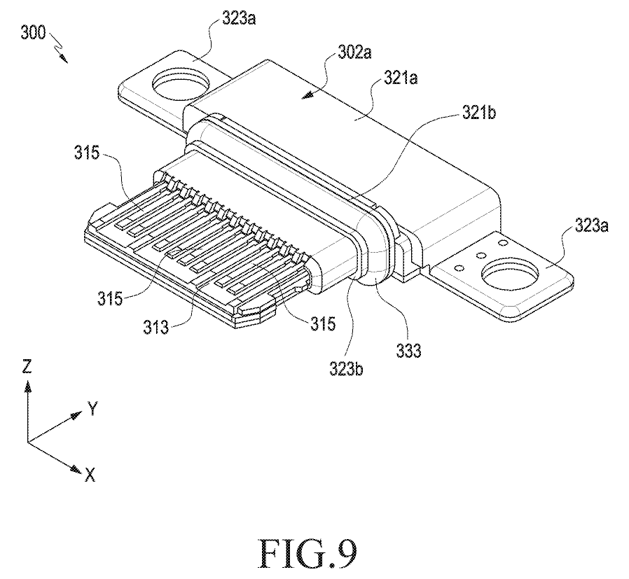

FIG. 6 is a perspective view illustrating a molded body 301 of a connector 300 (e.g., the connector 249a of FIGS. 4 or 5) according to an embodiment of the disclosure. FIG. 7 is a perspective view illustrating a state in which a second cover member 302b is coupled to the molded body 301 of the connector 300 according to an embodiment of the disclosure. FIG. 8 is a perspective view illustrating a state in which a first cover member 302a is coupled to the molded body 301 of the connector 300 according to an embodiment of the disclosure. FIG. 9 is a perspective view illustrating the connector 300 according to an embodiment of the disclosure, and illustrates a state in which a second sealing member 333 is disposed on the second cover member 302b.

Referring to FIGS. 6 to 9, the connector 300 may include a USB connector (e.g., a C-type connector), and may be disposed in an electronic device (e.g., the electronic devices 1001, 1002, 1004, 100, and 200 of FIGS. 1 to 5) to provide connection with an external electronic device or to be used for power supply. In an embodiment, the connector 300 may include a molded body 301, a first cover member 302a, a second cover member 302b, and/or a plurality of contact terminals 315. In an embodiment, the plurality of contact terminals 315 may be understood as a portion of the molded body 301.

According to an embodiment, the molded body 301 may be understood, for example, as a structure for disposing or fixing the contact terminals 315 and including a fixing portion 311 and a connection portion 313. In an embodiment, the connector 300 may include a first sealing member 331 configured to at least partially seal a space between the molded body 301 and the second cover member 302b inside the second cover member 302b, and a second sealing member 333 disposed to at least partially surround an outer circumferential surface of the second cover member 302b. For example, the first sealing member 331 may be disposed between the molded body 301 (e.g., the connection portion 313) and an inner circumferential surface of the second cover member 302b to implement a waterproofing/dustproofing structure. In an embodiment, when the connector 300 is disposed inside the electronic device 200 (e.g., the housing 201 of FIG. 5), the second sealing member 333 may implement a waterproofing/dustproofing structure between the connector 300 (e.g., the second cover member 302b) and the housing 201. Depending on specifications of the electronic device 200, at least one of the first sealing member 331 or the second sealing member 333 may be omitted.

Referring to FIG. 6, the connection portion 313 may extend from the fixing portion 311 in a first direction (e.g., the -Y direction). In an embodiment, the contact terminals 315 may be understood as extending from the fixing portion 311 in the first direction and being partially exposed to an external space on the connection portion 313. For example, the contact terminals 315 may be understood as extending in the first direction and being arranged along a second direction (e.g., an X-axis direction) crossing the first direction. As will be described with reference to FIG. 11, the contact terminals 315 may be partially embedded in the fixing portion 311 and may provide one or more contact pads 317 exposed on one surface of the fixing portion 311 (e.g., the surface oriented in the -Z direction). Depending on specifications of the electronic device 200 or an arrangement state inside the housing 201, the one or more contact pads 317 may be understood as being exposed on a surface of the fixing portion 311 oriented in the -Z direction. For example, the one or more contact pads 317 may substantially correspond to portions of the contact terminals 315 that are exposed on one surface of the fixing portion 311. In an embodiment, although the “-Z direction” is illustratively mentioned as a direction in which the one or more contact pads 317 are exposed, it should be noted that one or more embodiments of the disclosure are not limited thereto. For example, depending on manufacturing specifications of the electronic device or a user’s usage habit, arrangements direction of components may be described differently from that mentioned in an embodiment.

According to an embodiment, the contact terminals 315 may be disposed or fixed on the molded body 301 (e.g., the fixing portion 311 and/or the connection portion 313) simultaneously with molding of the molded body 301 through an insert injection molding process. For example, in a state in which the contact terminals 315 are disposed inside a mold, molten resin may be injected into the mold and cured, so that the molded body 301 is molded while the contact terminals 315 are substantially disposed on the molded body 301. The number and arrangement of the contact terminals 315 may be implemented differently depending on a use or specification of the connector 300.

According to an embodiment, before the first cover member 302a and/or the second cover member 302b are disposed, the first sealing member 331 may be disposed on the molded body 301. For example, the first sealing member 331 may be disposed to at least partially surround a circumference of the connection portion 313. In an embodiment, a structure in which the contact terminals 315 are exposed in a portion between the connection portion 313 and the fixing portion 311 may be implemented, and in this case, the first sealing member 331 may be understood as being disposed between the connection portion 313 and the fixing portion 311. For example, the first sealing member 331 may conceal or protect in part the one or more contact terminals between the connection portion 313 and the fixing portion 311.

According to an embodiment, the first sealing member 331 may be formed of, for example, an elastic material such as silicone or urethane. In an embodiment, the first sealing member 331 may have a closed curve shape. For example, when viewed along the Y-axis direction, the first sealing member 331 may be understood as being disposed to substantially surround the connection portion 313. In an embodiment, when viewed along the Y-axis direction, the first sealing member 331 may be understood as partially overlapping the connection portion 313 (or the fixing portion 311). In an embodiment, the first sealing member 331 may be manufactured in a ring shape and assembled to the connection portion 313, or may be implemented in a predetermined shape by applying a liquid resin around the connection portion 313 and cooling or curing the liquid resin.

Referring to FIGS. 7 and 8, the first cover member 302a may be disposed to surround at least a portion of the fixing portion 311, and the second cover member 302b may be coupled to at least partially surround a perimeter of the connection portion 313. In an embodiment, the first cover member 302a may have a bent plate shape. For example, the first cover member 302a may be a component molded using a synthetic resin or a component manufactured by processing a metal plate. In an embodiment, the second cover member 302b may have a closed curve shape. For example, when viewed in the Y-axis direction, the second cover member 302b may be understood as being disposed to surround the connection portion 313. The second cover member 302b may be, for example, a component molded using a synthetic resin or a component manufactured by processing a metal plate.

According to an embodiment, the first cover member 302a may include a cover portion 321a surrounding a portion of the fixing portion 311, and at least one fixing piece 323a extending from the cover portion 321a. In an embodiment, when a structure is implemented in which the contact terminals 315 (e.g., the one or more contact pads 317) are partially exposed on a surface of the fixing portion 311 oriented in the -Z direction, the cover portion 321a may substantially expose the surface on which the one or more contact pads 317 are disposed. In an embodiment, the cover portion 321a may have a closed curve shape surrounding the fixing portion 311, and in this case, the one or more contact pads 317 may be disposed on a surface of the fixing portion 311 oriented in the +Y direction. For example, the fixing piece 323a may be a portion extending in a second direction (e.g., the X-axis direction) from each of opposite ends of the cover portion 321a, and may provide means for disposing or fixing the connector 300 to a circuit board (e.g., the auxiliary circuit board 249 of FIGS. 5 or 18). Although no reference numeral is assigned, the fixing piece 323a may provide a hole penetrating through both surfaces thereof, and a fastening member such as a screw may dispose or fix the first cover member 302a and/or the connector 300 to another structure (e.g., the auxiliary circuit board 249 or the first support member 211 of FIG. 5).

According to an embodiment, the second cover member 302b may include a base portion 321b and a support portion 323b protruding from the base portion 321b in the Y-axis direction (e.g., the -Y direction). In an embodiment, the base portion 321b may be understood as a plate (or frame shape) disposed substantially parallel to the XZ plane. In an embodiment, when the second cover member 302b is disposed on the molded body 301, the base portion 321b may be disposed to face the fixing portion 311. For example, the base portion 321b may be disposed to substantially contact the fixing portion 311. In an embodiment, the second cover member 302b, for example, the base portion 321b, may be partially in substantial contact with the first cover member 302a (e.g., the cover portion 321a). In an embodiment, the base portion 321b may be formed integrally with the first cover member 302a (e.g., the cover portion 321a). In an embodiment, the support portion 323b may have a tubular shape extending from the base portion 321b in the -Y direction (and/or the +Y direction). For example, in a state in which the base portion 321b is disposed to face the fixing portion 311, the support portion 323b may be disposed to surround the connection portion 313. In an embodiment, the support portion 323b may be understood as being disposed to surround at least a portion of a region of the connection portion 313 in which the first sealing member 331 is disposed. For example, the first sealing member 331 may contact an inner circumferential surface of the support portion 323b, thereby implementing a waterproofing/dustproofing structure between the connection portion 313 and the second cover member 302b.

Referring to FIG. 9, the second sealing member 333 may be disposed to surround at least a portion of an outer surface of the second cover member 302b. For example, the second sealing member 333 may contact one surface (e.g., an outer surface) of the base portion 321b and may contact an outer surface of the support portion 323b. In an embodiment, in the Z-axis direction, the second sealing member 333 may be disposed to substantially overlap the first sealing member 331 with a portion of the support portion 323b interposed therebetween. For example, the first sealing member 331 and the second sealing member 333 may be disposed in a stacked structure in a thickness direction of the electronic device 200 or in a thickness direction of the connector 300, or may be disposed in a structure in which the second sealing member 333 surrounds a region in which the first sealing member 331 is disposed. In an embodiment, as the second sealing member 333 is disposed to surround the region in which the first sealing member 331 is disposed, the first sealing member 331 and the second sealing member 333 may be understood as being disposed in a single plane substantially parallel to the XZ plane.

According to an embodiment, the second sealing member 333 may be formed of, for example, an elastic material such as silicone or urethane. In an embodiment, the second sealing member 333 may have a closed curve shape. For example, when viewed along the Y-axis direction, the second sealing member 333 may be understood as being disposed to substantially surround the second cover member 302b (e.g., the support portion 323b). In an embodiment, when viewed along the Y-axis direction, the second sealing member 333 may be understood as partially overlapping the second cover member 302b (e.g., the base portion 321b). In an embodiment, the second sealing member 333 may be manufactured in a ring shape and assembled to the second cover member 302b, or may be implemented in a predetermined shape by applying a liquid resin around the second cover member 302b and cooling or curing the liquid resin.

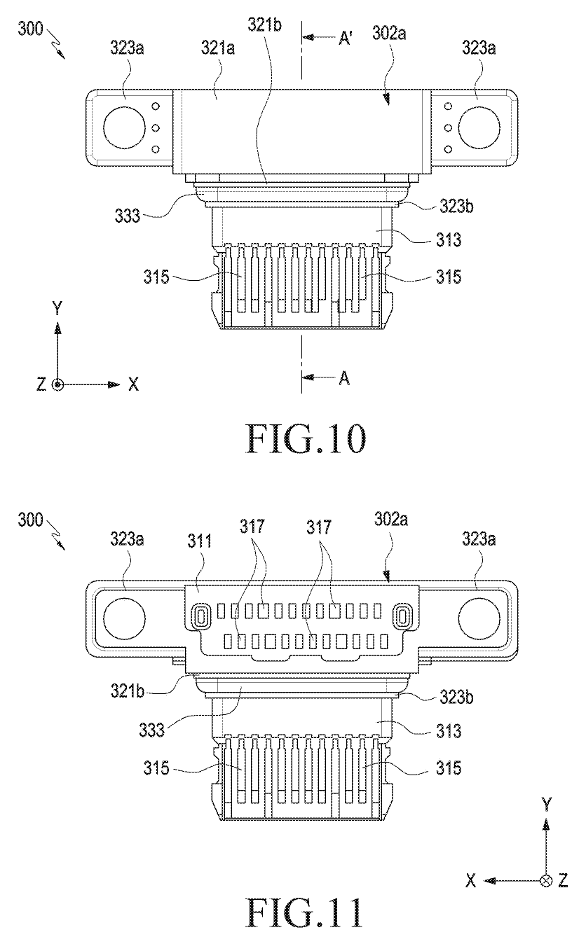

FIG. 10 is a plan view illustrating a connector 300 (e.g., the connector 300 of FIG. 9) according to an embodiment of the disclosure. FIG. 11 is a bottom view illustrating the connector 300 according to an embodiment of the disclosure.

Further referring to FIGS. 10 and 11, the first cover member 302a may be disposed to substantially conceal a surface of the fixing portion 311 oriented in the +Z direction, and the second cover member 302b (e.g., the base portion 321b and/or the support portion 323b) may be substantially concealed by the second sealing member 333. In an embodiment, in the state illustrated in FIGS. 10 or 11, the first sealing member 331 may be understood as being disposed to substantially overlap a region in which the second sealing member 333 is disposed. In an embodiment, the contact terminals 315 may be electrically connected to an external connector by being exposed to the outside of the second cover member 302b on at least one surface of the connection portion 313 (e.g., the surface oriented in the +Z direction). For example, when the connector 300 is connected to an external connector, at least a portion of the connection portion 313 may be understood as being received in the external connector.

According to an embodiment, a portion of the contact terminals 315 may be substantially embedded in the fixing portion 311, while end portions of the contact terminals 315 are exposed on a surface of the fixing portion 311 (e.g., the surface oriented in the -Z direction) to implement the one or more contact pads 317. In an embodiment, for example, a pair of fixing pieces 323a may be provided and may extend from opposite ends of the cover portion 321a in directions away from each other and be disposed substantially parallel to the XY plane. For example, the fixing piece 323a may be disposed to substantially face one surface of a circuit board (e.g., the auxiliary circuit board 249 of FIGS. 5 or 18).

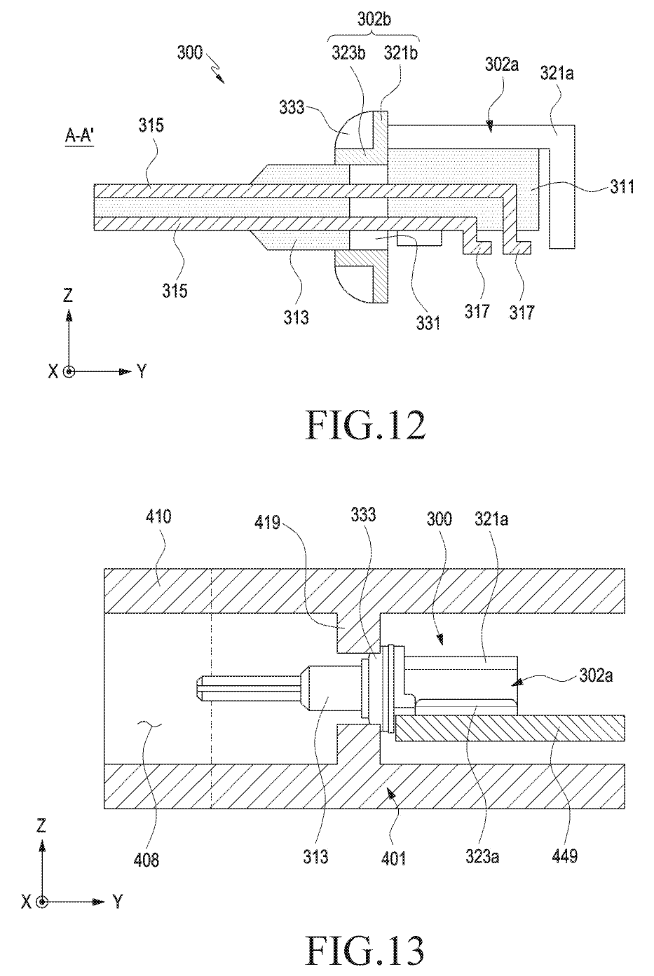

FIG. 12 is a cross-sectional view illustrating a connector 300 (e.g., the connector 300 of FIGS. 9 to 11), taken along line A-A′ of FIG. 10 according to an embodiment of the disclosure. FIG. 13 is a view illustrating a state in which the connector 300 is disposed in an electronic device (e.g., the electronic device 100 or 200 of FIGS. 2 to 5), for example, in a housing 401 (e.g., the housing 201 of FIGS. 4 or 5) according to an embodiment of the disclosure.

Further referring to FIGS. 12 and 13, the fixing portion 311 of the molded body (e.g., the molded body 301 of FIG. 6) may be disposed on a circuit board 449 (e.g., the auxiliary circuit board 249 of FIGS. 5 or 18), and the connection portion 313 may protrude from an edge of the circuit board 449 toward one side, for example, in the -Y direction. For example, the fixing portion 311 may be disposed such that a surface on which one or more contact pads 317 are disposed to directly face the circuit board 449, so that the contact terminals 315 may be electrically connected to the circuit board 449. The electronic device 200, for example, the housing 401, may include a connector hole 408 (e.g., the first connector hole 108 of FIG. 2) formed to penetrate a side wall 410 (e.g., the side structure 210 of FIG. 5), and a partition 419 disposed inside the housing 401 to face the connector hole 408. For example, the partition 419 may be understood as being disposed at a predetermined distance from the side wall 410. In an embodiment, the predetermined distance between the partition 419 and the side wall 410 may refer to a design value related to a length by which an external connector is inserted into or accommodated in the housing 401.

According to an embodiment, inside the housing 401, the connector hole 408 penetrating the side wall 410 and/or the partition 419 may substantially function as a receptacle configured to accommodate the external connector. For example, even though the connector 300 does not include a separate receptacle for coupling with the external connector, the connector 300 may be stably coupled with the external connector when disposed on the housing 401. In an embodiment, since a structure functioning as a receptacle may be omitted from the connector 300, the connector 300 may be miniaturized, and securing a space for disposing the connector 300 inside the housing 401 may be facilitated. In an embodiment, since the structure functioning as a receptacle may be omitted from the connector 300, the electronic device 200 and/or the housing 401 may be miniaturized.

According to an embodiment, inside the housing 401, the fixing portion 311 may be disposed on one side of the partition 419, and the connection portion 313 may penetrate the partition 419 and be disposed at least partially inside the connector hole 408. For example, the fixing portion 311 and/or the circuit board 449 may be understood as being disposed adjacent to the partition 419 inside the housing 401. In an embodiment, when viewed from the outside of the electronic device 200 or the housing 401, the connection portion 313 may be understood as being disposed to directly face the connector hole 408. In an embodiment, the second sealing member 333 may be disposed around the second cover member 302b (e.g., the support portion 323b) and may be disposed to contact the partition 419. For example, when the connection portion 313 is disposed inside the connector hole 408 through the partition 419 from one side of the partition 419, the second sealing member 333 may be in close contact with the partition 419 to implement a waterproofing/dustproofing structure. In implementing the waterproofing/dustproofing structure, the second sealing member 333 may substantially have a closed curve shape.

In describing one or more embodiments below, the connector 300 of one or more preceding embodiments may be referred to. In one or more embodiments below, components that may be easily understood from the preceding one or more embodiments may be assigned the same reference numerals as those in the preceding one or more embodiments or may omit such reference numerals, and detailed descriptions thereof may also be omitted. In one or more embodiments below, components to which the same reference numerals are assigned but for which detailed descriptions are omitted may be easily understood with reference to the configurations of the preceding one or more embodiments.

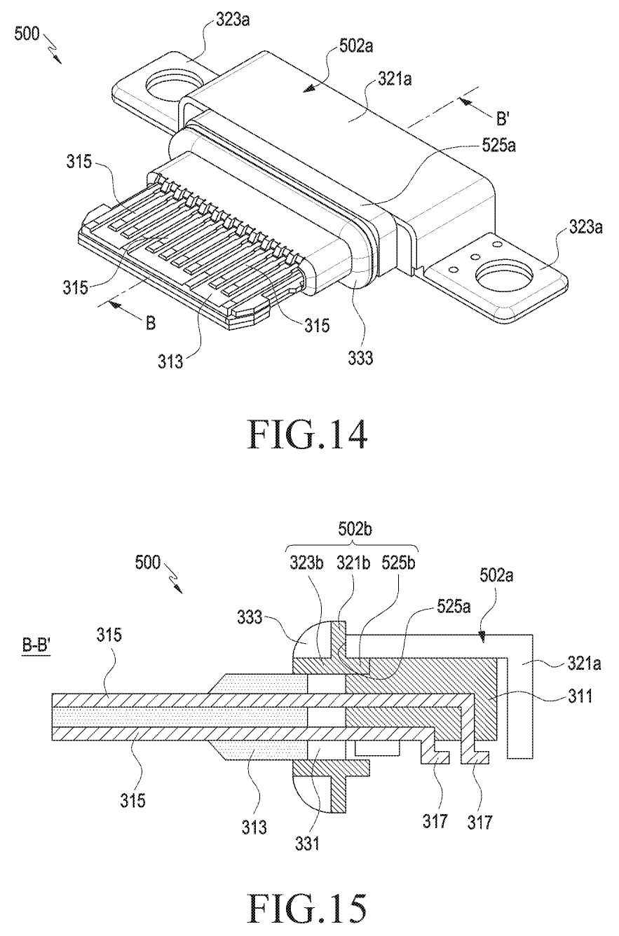

FIG. 14 is a perspective view illustrating a connector 500 (e.g., the connector 249a of FIG. 4 or the connector 300 of FIGS. 9 to 13) according to an embodiment of the disclosure. FIG. 15 is a cross-sectional view illustrating the connector 500, taken along line B-B′ of FIG. 14 according to an embodiment of the disclosure.

Referring to FIGS. 14 and 15, the connector 500 may further include a support piece 525a extending or protruding from one side of a first cover member 502a (e.g., the first cover member 302a of FIGS. 8 to 10), and a second support portion 525b protruding from a second cover member 502b (e.g., the base portion 321b). According to an embodiment, when the cover portion 321a is disposed to surround a portion of the fixing portion 311, the support piece 525a may be understood as protruding from the cover portion 321a in a direction toward the connection portion 313. In an embodiment, in a state in which the second cover member 502b is coupled to surround a portion of the connection portion 313, the second support portion 525b may be positioned inside the support piece 525a. For example, the support piece 525a may be understood as being disposed to surround at least a portion of the second support portion 525b. In an embodiment, the support piece 525a may be fused, bonded, or welded to the second support portion 525b. For example, an inner surface of the support piece 525a may be disposed to face an outer surface of the second support portion 525b, and depending on a material, the first cover member 502a and the second cover member 502b may be substantially coupled or fixed to each other by fusion, bonding, or welding.

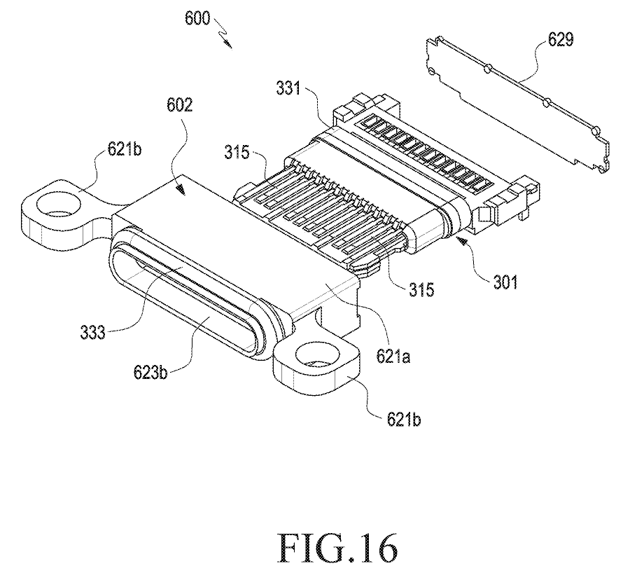

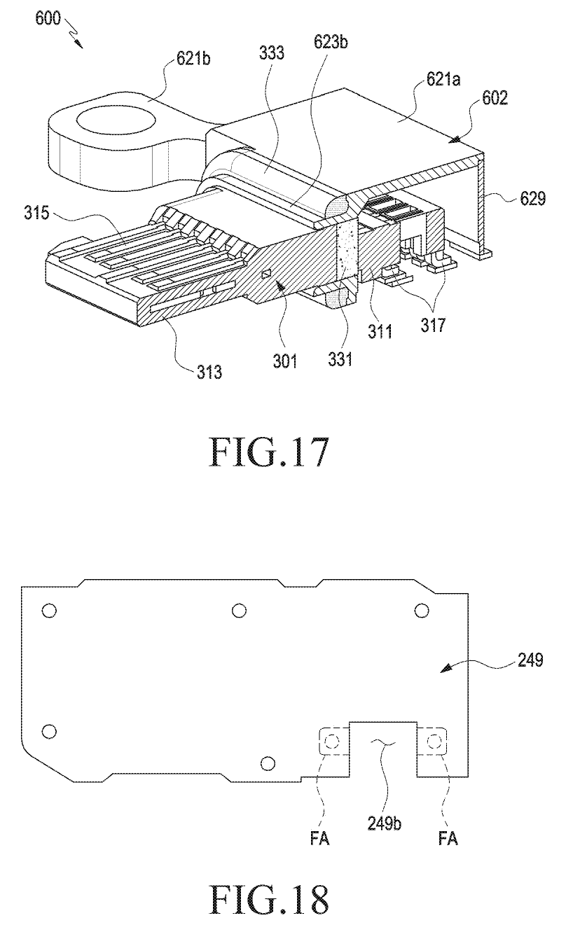

In an embodiment, the connector 300 or 500 described above may include a cover member in which the first cover member 302a or 502a and the second cover member 302b or 502b are integrally implemented. A cover member in which the first cover member 302a or 502a and the second cover member 302b or 502b are implemented as a one-piece or single body will be described with reference to FIGS. 16 and 17.

FIG. 16 is an exploded perspective view illustrating a connector 600 (e.g., the connector 249a of FIG. 4, the connector 300 of FIGS. 9 to 13, or the connector 500 of FIGS. 14 and 15) according to an embodiment of the disclosure. FIG. 17 is a perspective view illustrating the connector 600, in which a portion of the connector 600 is cut away according to an embodiment of the disclosure.

Referring to FIGS. 16 and 17, a second cover member 623b (e.g., the second cover member 302b of FIGS. 7 or 8) may be integrally provided at one side edge of a first cover member 621a (e.g., the first cover member 302a of FIGS. 8 or 9) to implement a cover member 602. In an embodiment, as in the embodiment of FIGS. 14 or 15, the second cover member 623b may be understood as being joined to an inner surface of the first cover member 621a by welding. A first sealing member 331 may be provided to at least partially surround a circumference of a molded body 301 (e.g., the connection portion 313 of FIG. 6), and may be in close contact with an inner surface of the second cover member 623b in a state in which the cover member 602 and the molded body 301 are coupled. Similar to the preceding one or more embodiments, the second cover member 623b and the first sealing member 331 may substantially have a closed curve shape, thereby implementing a waterproofing/dustproofing structure between the molded body 301 and the cover member 602 (e.g., the second cover member 623b).

According to an embodiment, the cover member 602 may further include a dummy cover 629 coupled to a rear side of the first cover member 621a to conceal a portion of the molded body 301. In an embodiment, when the cover member 602 is made of an electrically conductive material, the cover member 602 may provide an electromagnetic shielding structure to a portion of the molded body 301. In this case, the dummy cover 629 may implement the electromagnetic shielding structure together with the first cover member 621a. In an embodiment, when the cover member 602 is configured to provide the electromagnetic shielding structure, one or more fixing pieces 621b extending from the first cover member 621a may be understood as being electrically connected to an auxiliary circuit board (e.g., the auxiliary circuit board 249 of FIGS. 5 or 18).

According to an embodiment, the connector 600 may include a second sealing member 333 disposed to contact an outer surface of the cover member 602, for example, an outer surface of the second cover member 623b. When the connector 600 is coupled to a housing (e.g., the housing 401 of FIG. 13), the second sealing member 333 may be in close contact with an internal structure of the housing 401 (e.g., the partition 419 of FIG. 13), thereby forming a waterproofing/dustproofing structure between the connector 600 and the housing 401. In an embodiment, the connector 600 and/or the cover member 602 may include one or more fixing pieces 621b. The one or more fixing pieces 621b may, for example, extend from the cover member 602 (e.g., the first cover member 621a) and may be disposed to face one surface of a circuit board (e.g., the auxiliary circuit board 249 of FIGS. 5 or 18). For example, by fastening a fastening member such as a screw to the circuit board or the housing 401 through the one or more fixing pieces 621b, the connector 600 may be fixed inside the housing 401.

FIG. 18 is a view illustrating a circuit board (e.g., the auxiliary circuit board 249 of FIGS. 4 or 5) to which a connector (e.g., the connector 300, 500, or 600 of FIGS. 9, 14, and/or 16) is coupled according to an embodiment of the disclosure.

Further referring to FIG. 18 together with FIG. 13, the circuit board, for example, the auxiliary circuit board 249 of FIG. 5, may be disposed adjacent to the partition 419 inside the housing 401, thereby allowing a portion of the connector 300, 500, or 600 (e.g., the connection portion 313) to be disposed in the connector hole 408. In an embodiment, when the connector 300, 500, or 600 is disposed in the housing 401, the connection portion 313 may be understood as facing the connector hole 408. In an embodiment, the auxiliary circuit board 249 may provide an accommodation hole 249b extending inward from an edge thereof. For example, the accommodation hole 249b may be provided in a shape (or size) corresponding to the fixing portion 311 of the molded body (e.g., the molded body 301 of FIG. 6) or the cover portion 321a of the first cover member 302a. For example, when the connector 300, 500, or 600 is disposed on the auxiliary circuit board 249, the accommodation hole 249b may receive a portion of the connector 300, 500, or 600 (e.g., the fixing portion 311 of the molded body or the cover portion 321a of the first cover member 302a).

According to an embodiment, in FIG. 18, regions indicated by “FA” at opposite sides of the accommodation hole 249b may illustrate, for example, regions in which one or more fixing pieces (e.g., the fixing pieces 323a of FIG. 9 or the fixing pieces 621b of FIG. 16) are disposed. For example, the fixing pieces 323a may be respectively provided at the opposite sides of the fixing portion 311 of the molded body or the cover portion 321a of the first cover member 302a. When the auxiliary circuit board 249 includes the accommodation hole 249b, a space required for disposing the connector 300, 500, or 600 may be reduced. For example, since a portion of the connector 300, 500, or 600 is disposed within the accommodation hole 249b, miniaturization of the housing 401 or the electronic device 200 may be facilitated.

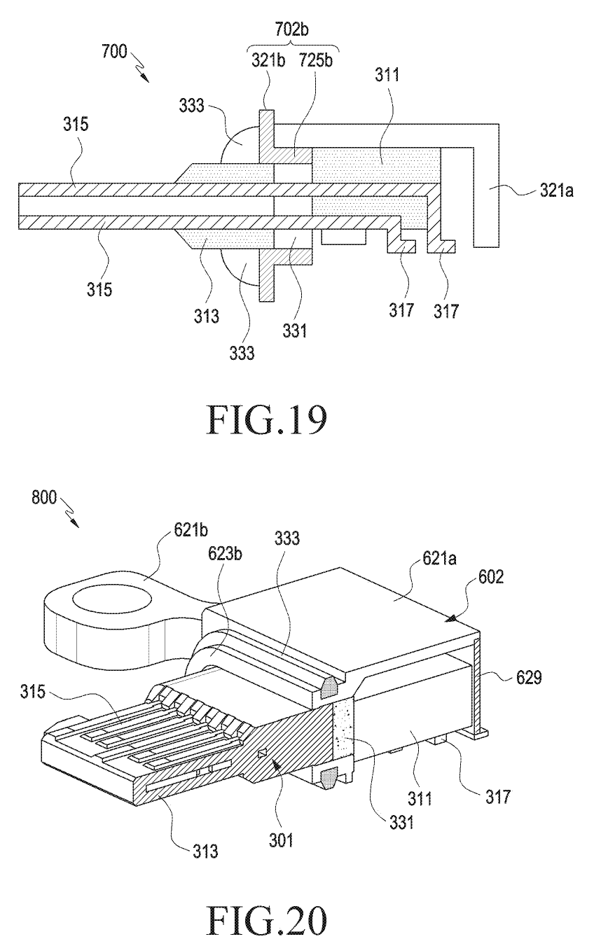

FIG. 19 is a cross-sectional view illustrating a connector 700 (e.g., the connector 300, 500, or 600 of FIGS. 9, 14, and/or 16), in which a portion of the connector 700 is cut away according to an embodiment of the disclosure.

Referring to FIG. 19, the connector 700 may include a second cover member 702b disposed at least partially inside a cover portion 321a (e.g., the first cover member 302a of FIGS. 8 to 10). For example, the second cover member 702b may include a second support portion 725b protruding from a base portion 321b. In an embodiment, the base portion 321b may be disposed to contact one side edge of the cover portion 321a and/or may be integrally formed with the cover portion 321a. When the base portion 321b is disposed to contact the cover portion 321a, the second support portion 725b may be disposed inside the cover portion 321a. For example, in a state in which the second cover member 702b is coupled to surround a portion of a connection portion 313, the second support portion 725b may be surrounded by the cover portion 321a. In an embodiment, the second support portion 725b may be fused, bonded, or welded to the cover portion 321a. For example, the second support portion 725b may be disposed to face an inner surface of the cover portion 321a, and depending on a material, the cover portion 321a and the second cover member 702b may be substantially coupled or fixed to each other by fusion, bonding, or welding.

FIG. 20 is a perspective view illustrating a connector 800 (e.g., the connector 300, 500, 600, or 700 of FIGS. 9,14, 16, and/or 19), in which a portion of the connector is cut away according to an embodiment of the disclosure.

Referring to FIG. 20, a second cover member 623b (e.g., the second cover member 302b of FIGS. 7 or 8) may be integrally provided at one side edge of a first cover member 621a (e.g., the first cover member 302a of FIGS. 8 or 9) to implement a cover member 602. In an embodiment, as in the embodiment of FIGS. 14, 15, or 19, the second cover member 623b may be understood as being joined to an inner surface of the first cover member 621a by welding. A first sealing member 331 may be provided to at least partially surround a circumference of a molded body 301 (e.g., the connection portion 313 of FIG. 6), and may be in close contact with an inner surface of the second cover member 623b in a state in which the cover member 602 and the molded body 301 are coupled. Similar to the preceding one or more embodiments, the second cover member 623b and the first sealing member 331 may substantially have a closed curve shape, thereby implementing a waterproofing/dustproofing structure between the molded body 301 and the cover member 602 (e.g., the second cover member 623b).

According to an embodiment, the cover member 602 may further include a dummy cover 629 coupled to a rear side of the first cover member 621a to conceal a portion of the molded body 301. In an embodiment, when the cover member 602 is made of an electrically conductive material, the cover member 602 may provide an electromagnetic shielding structure to a portion of the molded body 301. In this case, the dummy cover 629 may implement the electromagnetic shielding structure together with the first cover member 621a. In an embodiment, when the cover member 602 is configured to provide the electromagnetic shielding structure, one or more fixing pieces 621b extending from the first cover member 621a may be understood as being electrically connected to an auxiliary circuit board (e.g., the auxiliary circuit board 249 of FIGS. 5 or 18).

According to an embodiment, the connector 800 may include a second sealing member 333 disposed to contact an outer surface of the cover member 602, for example, an outer surface of the second cover member 623b. In an embodiment, the second sealing member 333 may be implemented as an O-ring or a liquid silicone material. When the connector 800 is coupled to a housing (e.g., the housing 401 of FIG. 13), the second sealing member 333 may be in close contact with an internal structure of the housing 401 (e.g., the partition 419 of FIG. 13), thereby forming a waterproofing/dustproofing structure between the connector 800 and the housing 401. In an embodiment, although no reference numeral is assigned, a fastening groove may be provided on an outer circumferential surface of the second cover member 623b. For example, when implemented as an O-ring or a liquid silicone material, the second sealing member 333 may be substantially fixed at a predetermined position on the outer circumferential surface of the second cover member 623b.

According to an embodiment, the connector 800 and/or the cover member 602 may include one or more fixing pieces 621b. The one or more fixing pieces 621b may, for example, extend from the cover member 602 (e.g., the first cover member 621a) and may be disposed to face one surface of a circuit board (e.g., the auxiliary circuit board 249 of FIGS. 5 or 18). For example, by fastening a fastening member such as a screw to the circuit board or the housing 401 through the one or more fixing pieces 621b, the connector 800 may be fixed inside the housing 401.

As described above, in a connector (e.g., the connector 300, 500, or 600 of FIGS. 9, 14, and/or 16) according to an embodiment of the disclosure, a receptacle structure for coupling or fastening with an external connector may be omitted. For example, an electronic device (e.g., the electronic device 1001, 1002, 1004, 100, or 200 of FIGS. 1 to 5) may be miniaturized by an amount corresponding to a space that would otherwise need to be secured inside the electronic device due to the receptacle. In an embodiment, a waterproofing/dustproofing structure may be implemented substantially within a thickness range of the connector or within a thickness range of a cover member (e.g., the first cover member 302a of FIGS. 8 or 9), thereby improving durability or reliability of the electronic device while suppressing an increase in the size (e.g., thickness) of the electronic device.

The effects obtainable from the disclosure are not limited to those described above, and other effects not mentioned herein will be clearly understood by a person ordinarily skilled in the art to which the disclosure pertains from the description of one or more embodiments described above.

According to an embodiment of the disclosure, a connector (e.g., the connector 249a of FIG. 4 or the connector 300 of FIGS. 9 to 13) may include a fixing portion (e.g., the fixing portion 311 of FIGS. 6 or 7), a connection portion (e.g., the connection portion 313 of FIGS. 6 to 9) extending in a first direction from the fixing portion, a first cover member (e.g., the first cover member 302a of FIGS. 8 or 9) disposed to surround at least a portion of the fixing portion, a second cover member (e.g., the second cover member 302b of FIGS. 7 or 8) disposed adjacent to the fixing portion or the first cover member and surrounding at least a portion of the connection portion, and a plurality of contact terminals (e.g., the contact terminals 315 of FIGS. 6 to 9) extending from the fixing portion, partially exposed to the outside of the second cover member on one surface of the connection portion, and arranged along a second direction crossing the first direction.

According to an embodiment, the connector as described above may further include a first sealing member (e.g., the first sealing member 331 of FIGS. 6 or 16) disposed between the connection portion and an inner circumferential surface of the second cover member.

According to an embodiment, the connector as described above may further include a second sealing member (e.g., the second sealing member 333 of FIGS. 9 to 13) disposed to surround at least a portion of an outer circumferential surface of the second cover member.

According to an embodiment, the connector as described above may further include a first sealing member disposed between the connection portion and an inner circumferential surface of the second cover member, and a second sealing member disposed to surround at least a portion of an outer circumferential surface of the second cover member. In an embodiment, the second cover member may include a base portion (e.g., the base portion 321b of FIGS. 7 or 8) disposed to face the fixing portion while contacting the second sealing member on an outer surface thereof or integrally formed with the first cover member, and a support portion (e.g., the support portion 323b of FIGS. 7 or 8) protruding from the base portion in the first direction and disposed to surround the connection portion. In an embodiment, the second sealing member may contact an outer surface of the support portion, and the first sealing member may contact an inner surface of the support portion.

According to an embodiment, at least one of the first sealing member and the second sealing member may have a closed curve shape.

According to an embodiment, the second cover member may have a closed curve shape.

According to an embodiment, the first cover member may include a cover portion (e.g., the cover portion 321a of FIGS. 8 or 9) surrounding a portion of the fixing portion, and at least one fixing piece (e.g., the fixing piece 323a of FIGS. 8 or 9) extending in the second direction from the cover portion.

According to an embodiment of the disclosure, a connector (e.g., the connector 249a of FIG. 4 or the connector 300 of FIGS. 9 to 13) may include a fixing portion (e.g., the fixing portion 311 of FIGS. 6 or 7), a connection portion (e.g., the connection portion 313 of FIGS. 6 to 9) extending in a first direction from the fixing portion, a first cover member (e.g., the first cover member 302a of FIGS. 8 or 9) disposed to surround at least a portion of the fixing portion, a second cover member (e.g., the second cover member 302b of FIGS. 7 or 8) disposed adjacent to the fixing portion or the first cover member and surrounding at least a portion of the connection portion, a plurality of contact terminals (e.g., the contact terminals 315 of FIGS. 6 to 9) extending on the fixing portion and partially exposed to the outside of the second cover member on one surface of the connection portion, a first sealing member (e.g., the first sealing member 331 of FIGS. 6 or 16) disposed between the connection portion and an inner circumferential surface of the second cover member, and a second sealing member (e.g., the second sealing member 333 of FIGS. 9 to 13) disposed to surround at least a portion of an outer circumferential surface of the second cover member. In an embodiment, the second cover member may include a base portion (e.g., the base portion 321b of FIGS. 7 or 8) disposed to face the fixing portion while contacting the second sealing member on an outer surface thereof, and a support portion (e.g., the support portion 323b of FIGS. 7 or 8) protruding from the base portion in the first direction and disposed to surround the connection portion. In an embodiment, the support portion may contact the second sealing member on an outer surface thereof and may contact the first sealing member on an inner surface thereof.

According to an embodiment, at least one of the first sealing member and the second sealing member may have a closed curve shape.

According to an embodiment, the second cover member may have a closed curve shape.

According to an embodiment, the first cover member may include a cover portion (e.g., the cover portion 321a of FIGS. 8 or 9) surrounding a portion of the fixing portion, and at least one fixing piece (e.g., the fixing piece 323a of FIGS. 8 or 9) extending in the second direction from the cover portion.

According to an embodiment of the disclosure, an electronic device (e.g., the electronic devices 1001, 1002, 1004, 100, and 200 of FIGS. 1 to 5) may include a housing (e.g., the housing 201 of FIG. 5 or the housing 401 of FIG. 13) including a front surface (e.g., the first surface 110A of FIG. 2), a rear surface facing in an opposite direction to the front surface (e.g., the second surface 110B of FIG. 3), and a side wall (e.g., the side structure 210 of FIG. 5 or the side wall 410 of FIG. 13) disposed to surround at least a portion of a space between the front surface and the rear surface, a connector hole (e.g., the first connector hole 108 of FIG. 2 or the connector hole 408 of FIG. 13) formed to pass through the side wall, a partition (e.g., the partition 419 of FIG. 13) provided inside the housing at a predetermined distance from the side wall and disposed to face the connector hole, and a connector (e.g., the connector 249a of FIG. 4 or the connector 300 of FIGS. 9 to 13) disposed inside the housing. In an embodiment, the connector may include a fixing portion (e.g., the fixing portion 311 of FIGS. 6 or 7) disposed on one side of the partition, a connection portion (e.g., the connection portion 313 of FIGS. 6 to 9) extending in a first direction from the fixing portion and disposed to pass through the partition so as to be disposed to directly face the connector hole, a first cover member (e.g., the first cover member 302a of FIGS. 8 or 9) disposed to surround at least a portion of the fixing portion, a second cover member (e.g., the second cover member 302b of FIGS. 7 or 8) disposed adjacent to the fixing portion or the first cover member and surrounding at least a portion of the connection portion, a first sealing member (e.g., the first sealing member 331 of FIGS. 6 or 16) disposed between the connection portion and an inner circumferential surface of the second cover member, and a second sealing member (e.g., the second sealing member 333 of FIGS. 9 to 13) disposed to surround at least a portion of an outer circumferential surface of the second cover member and directly contacting the partition.

According to an embodiment, the connector may include a plurality of contact terminals (e.g., the contact terminals 315 of FIGS. 6 to 9) extending from the fixing portion and partially exposed to the outside of the second cover member on one surface of the connection portion, the plurality of contact terminals being arranged along a second direction crossing the first direction.

According to an embodiment, the second cover member may include a base portion (e.g., the base portion 321b of FIGS. 7 or 8) disposed to face the fixing portion while contacting the second sealing member on an outer surface thereof, and a support portion (e.g., the support portion 323b of FIGS. 7 or 8) protruding from the base portion in the first direction and disposed to surround the connection portion.

According to an embodiment, the support portion may contact the second sealing member on an outer surface thereof and may contact the first sealing member on an inner surface thereof.

According to an embodiment, at least one of the first sealing member and the second sealing member may have a closed curve shape.

According to an embodiment, the second cover member may have a closed curve shape.

According to an embodiment, the first cover member may include a cover portion surrounding a portion of the fixing portion and at least one fixing piece extending in the second direction from the cover portion.

According to an embodiment, the electronic device as described above may further include a circuit board (e.g., the auxiliary circuit board 249 of FIGS. 5 or 18) disposed inside the housing adjacent to the partition. In an embodiment, the connector may be fixed to one surface of the circuit board by the at least one fixing piece.

According to an embodiment, the circuit board may provide an accommodation hole (e.g., the accommodation hole 249b of FIG. 18) extending inward from an edge thereof. In an embodiment, the first cover member may be disposed such that the cover portion is positioned on the accommodation hole and the fixing piece faces one surface of the circuit board.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A connector, comprising:
a fixing portion;
a connection portion extending in a first direction from the fixing portion;
a first cover member disposed to surround at least a portion of the fixing portion;
a second cover member disposed adjacent to the fixing portion or the first cover member, the second cover member surrounding at least a portion of the connection portion; and
a plurality of contact terminals extending from the fixing portion, the plurality of contact terminals being partially exposed to an outside of the second cover member on one surface of the connection portion, the plurality of contact terminals being arranged along a second direction intersecting the first direction.

2. The connector of claim 1, further comprising:
a first sealing member disposed between the connection portion and an inner circumferential surface of the second cover member.

3. The connector of claim 1, further comprising:
a second sealing member disposed to surround at least a portion of an outer circumferential surface of the second cover member.

4. The connector of claim 1, further comprising:
a first sealing member disposed between the connection portion and an inner circumferential surface of the second cover member; and
a second sealing member disposed to surround at least a portion of an outer circumferential surface of the second cover member,
wherein the second cover member comprises:
a base portion disposed to either face the fixing portion or be integrally formed with the first cover member and contact the second sealing member on an outer surface of the base portion, and
a support portion protruding from the base portion in the first direction, the support portion being disposed to surround the connection portion,
wherein the second sealing member contacts an outer surface of the support portion, and
wherein the first sealing member contacts an inner surface of the support portion.

5. The connector of claim 4, wherein at least one of the first sealing member or the second sealing member comprises a closed curve shape.

6. The connector of claim 1, wherein the second cover member comprises a closed curve shape.

7. The connector of claim 1, wherein the first cover member comprises:
a cover portion surrounding a portion of the fixing portion; and
at least one fixing piece extending in the second direction from the cover portion.

8. An electronic device, comprising:
a housing comprising a front surface, a rear surface facing in a direction opposite to the front surface, and a side wall disposed to surround at least a portion of a space between the front surface and the rear surface;
a connector hole formed through the side wall;
a partition disposed inside the housing at a predetermined distance from the side wall, the partition facing the connector hole; and
a connector disposed inside the housing,
wherein the connector comprises:
a fixing portion disposed on one side of the partition,
a connection portion extending in a first direction from the fixing portion, the connection portion being disposed to pass through the partition such that the connection portion directly faces the connector hole,
a first cover member disposed to surround at least a portion of the fixing portion,
a second cover member disposed adjacent to the fixing portion or the first cover member, the second cover member surrounding at least a portion of the connection portion,
a first sealing member disposed between the connection portion and an inner circumferential surface of the second cover member, and
a second sealing member disposed to surround at least a portion of an outer circumferential surface of the second cover member and directly contact the partition.

9. The electronic device of claim 8, wherein the second cover member includes:
a base portion disposed to face the fixing portion and contact the second sealing member on an outer surface thereof; and
a support portion protruding from the base portion in the first direction, the support portion being disposed to surround the connection portion.

10. The electronic device of claim 9,
wherein the support portion contacts the second sealing member on an outer surface thereof, and
wherein the support portion contacts the first sealing member on an inner surface thereof.

11. The electronic device of claim 8, wherein at least one of the first sealing member or the second sealing member comprises a closed curve shape.

12. The electronic device of claim 8, wherein the second cover member comprises a closed curve shape.

13. The electronic device of claim 8, wherein the first cover member includes:
a cover portion surrounding a portion of the fixing portion; and
at least one fixing piece extending in a second direction from the cover portion, the second direction intersecting the first direction.

14. The electronic device of claim 13, further comprising:
a circuit board disposed inside the housing adjacent to the partition,
wherein the connector is fixed to one surface of the circuit board by the at least one fixing piece.

15. The electronic device of claim 14,
wherein the circuit board provides an accommodation hole extending inward from an edge thereof, and
wherein the first cover member is disposed such that the cover portion is positioned in the accommodation hole and the at least one fixing piece faces the one surface of the circuit board.

16. The connector of claim 4,
wherein the second cover member further comprises a second support portion protruding from the base portion in a direction opposite to the first direction, and
wherein the second support portion is disposed within a support piece that surrounds at least a portion of the second support portion.

17. The electronic device of claim 9,
wherein the second cover member further comprises a second support portion protruding from the base portion in a direction opposite to the first direction, and
wherein the second support portion is disposed within a support piece that surrounds at least a portion of the second support portion.

18. The connector of claim 1, further comprising:
a first sealing member disposed between the connection portion and an inner circumferential surface of the second cover member; and
a second sealing member disposed to surround at least a portion of an outer circumferential surface of the second cover member,
wherein the second cover member comprises:
a base portion disposed to either face the fixing portion or be integrally formed with the first cover member and contact the second sealing member on an outer surface of the base portion, and
a second support portion protruding from the base portion in a direction opposite to the first direction, and
wherein the second support portion is disposed within the first cover member that surrounds at least a portion of the second support portion.

19. The electronic device of claim 8,
wherein the second cover member includes:
a base portion disposed to either face the fixing portion or be integrally formed with the first cover member and contact the second sealing member on an outer surface of the base portion, and
a second support portion protruding from the base portion in a direction opposite to the first direction, and
wherein the second support portion is disposed within the first cover member that surrounds at least a portion of the second support portion.
